(19) United States
(12) Patent Application Publication
(10) Pub. No.: US 2018/0212551 A1
(43) Pub. Date: Jul. 26, 2018

(54) MOBILE SOLAR COLLECTOR AND ELECTRICITY PRODUCTION SYSTEM

(71) Applicant: Steven A. POLK, West Bloomfield, MI (US)

(72) Inventor: Steven A. POLK, West Bloomfield, MI (US)

(73) Assignee: DIVERSIFIED SOLAR SYSTEMS, LLC, Bingham Farms, MI (US)

(21) Appl. No.: 15/759,415

(22) PCT Filed: Sep. 10, 2016
(86) PCT No.: PCT/US2016/051188

§ 371 Date: Mar. 12, 2018

Related U.S. Application Data
(60) Provisional application No. 62/216,874, filed on Sep. 10, 2015.

(51) Int. Cl. H02S 10/40; H02J 7/35; H02S 20/32; H02S 40/38

(52) U.S. Cl. CPC H02S 10/40; H02J 7/355; F24J 2/36; H02S 40/38; B63B 2209/18; H02S 20/32

(57) ABSTRACT

An electricity production system may include a solar energy collector for receiving sunlight and providing electricity to an electrical load. The system may include a battery for storing energy and providing electricity to the electrical load. The system may include a generator for providing electricity to the electrical load. The system may include a controller programmed to issue commands to distribute electrical output such that electricity required for the load is available from at least one of the solar energy collector, the battery, and the generator. The commands may reduce usage of the battery and generator based on at least one of an anticipated sun load and expected customer usage.

### TECHNICAL FIELD

One or more embodiments relate to solar energy collection, and more particularly to a mobile and collapsible electricity production system.

### BACKGROUND

Solar collectors are generally provided for collecting energy from the sun. One type of solar collector includes a reflective surface and a collector assembly coupled together for receiving solar energy and using the energy for heating a fluid. The reflective surface focuses sunlight at a focal point. A receiver may be positioned at the focal point, circulating fluid through the receiver to absorb heat. Solar energy is harvested from the heated fluid after circulation. The heat energy may be converted into other forms of energy, such as electricity. Alternatively some solar collectors position a heat engine adjacent to the receiver for harvesting solar energy.

Another type of solar collector includes a photo-voltaic (PV) type. PV panels, comprised of layers of semi-conductor material, receive photons from sunlight and develop a voltage differential between the layers. When a PV panel is connected to an electrical load during this condition, an electrical current is produced because of the voltage differential. Panels may be used in quantities to harness the total energy collected by multiple panels.

Installing permanent PV panels often faces infrastructure and space constraints. Also, static systems may not be optimal for transient external conditions. It is desirable to have a solar collection unit that is flexible and configurable for various environmental conditions.

### SUMMARY

An electricity production system may include a solar energy collector for receiving sunlight and providing electricity to an electrical load. The system may include a battery for storing energy and providing electricity to the electrical load. The system may include a generator for providing electricity to the electrical load. The system may include a controller programmed to issue commands to distribute electrical output such that electricity required for the load is available from at least one of the solar energy collector, the battery, and the generator. The commands may reduce usage of the battery and generator based on at least one of an anticipated sun load and expected customer usage.

A mobile electricity production system may include a trailer including a frame, a plurality of wheels, and a hitch. The mobile system may include a solar collector panel array pivotally attached to the frame and articulable to receive sunlight and output electricity. The mobile system may include a generator attached to the frame and configured to output electricity. The mobile system may include a battery attached to the frame and configure to store electricity and to output electricity. The mobile system may include a controller programmed to issue commands to distribute electrical output such that electricity required for an electrical load is satisfied from at least one of the solar collector panel array, the battery, and the generator.

### BRIEF DESCRIPTION OF THE DRAWINGS

FIG. 1 is a side elevation view of a mobile electricity production system in a transport configuration.

FIG. 2 is a rear view of the mobile electricity production system of FIG. 1 in a transport configuration.

FIG. 3 is a side view of the mobile electricity production system of FIG. 1 in a transport configuration.

FIGS. 4A-C are a schematic of a collapsible solar collector panel array.

FIG. 5 is side view of a strut profile of the mobile electricity production system of FIG. 1.

FIG. 6 is an elevation view of a first deployment step of the mobile electricity production system of FIG. 1.

FIG. 7 is an elevation view of a second deployment step of the mobile electricity production system of FIG. 1.

FIG. 8 is an elevation view of a third deployment step of the mobile electricity production system of FIG. 1.

FIG. 9 is an elevation view of a fourth deployment step of the mobile electricity production system of FIG. 1.

FIG. 10 is an elevation view of a fifth deployment step of the mobile electricity production system of FIG. 1.

FIG. 11 is an end view of a support arm securement to a solar collector panel perimeter frame.

FIG. 12 is an elevation view of a sixth deployment step of the mobile electricity production system of FIG. 1.

FIG. 13 is an elevation view of a seventh deployment step of the mobile electricity production system of FIG. 1.

FIG. 14 is an elevation view of an eighth deployment step of the mobile electricity production system of FIG. 1.

FIG. 15 is an elevation view of a ninth deployment step of the mobile electricity production system of FIG. 1.

FIG. 16 is a flowchart of deployment steps of solar collector panels of a mobile electricity production system.

FIG. 17 is a side view of the mobile electricity production system of FIG. 1 in a deployed configuration.

FIG. 18 is an elevation view of a pitch adjustment mechanism.

FIG. 19 is a perspective view of lateral stabilizers of a gear plate of the pitch actuator.

FIG. 20 is an elevation view of rotation adjustment mechanism.

FIG. 21 is a perspective view of backside portion of the mobile electricity production system of FIG. 1.

FIG. 22 is a system diagram of power distribution components of a electricity production system.

FIGS. 23A and 23B are a flowchart of a method for providing power to an electrical load.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to understand various aspects of the design.

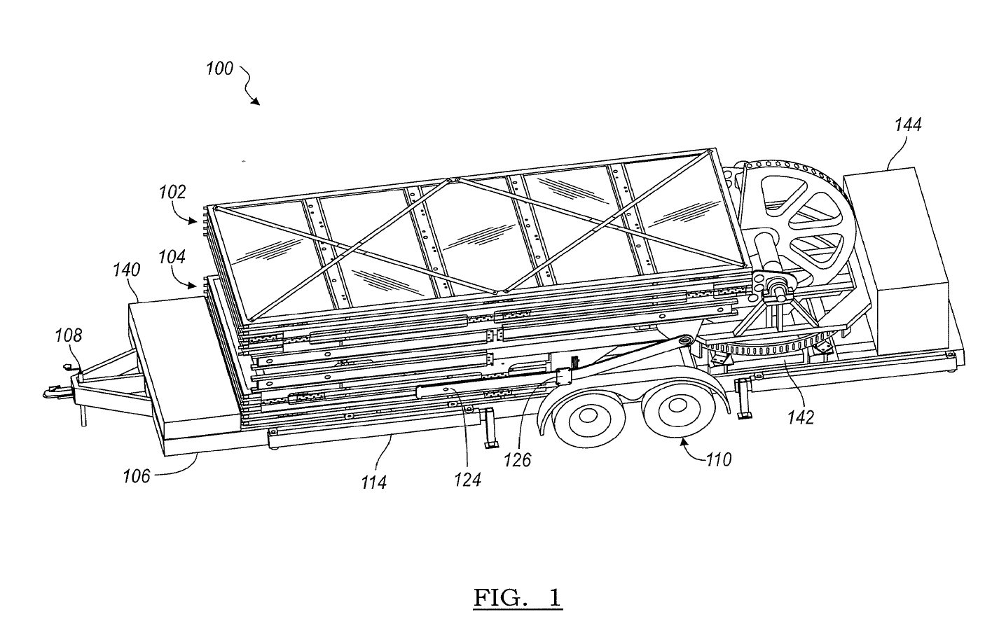

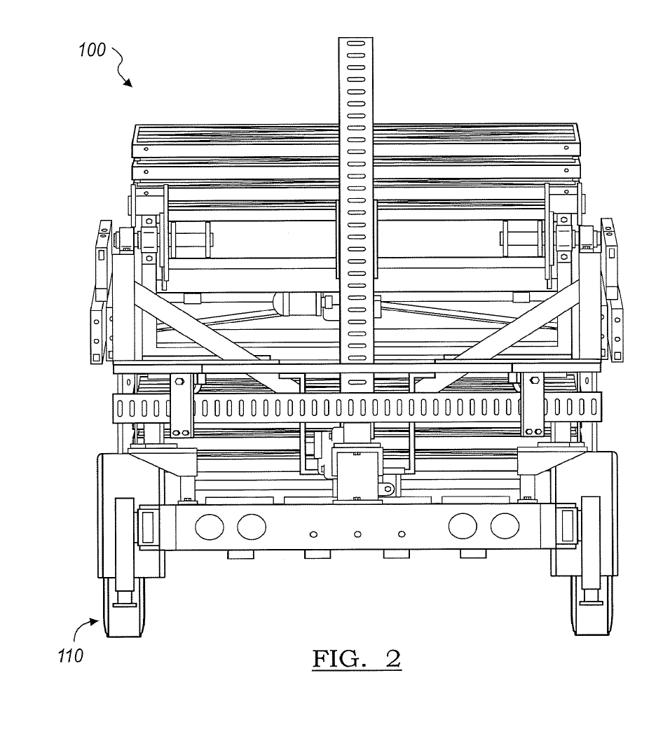

Referring to FIGS. 1 through 3, a mobile electricity production system 100 is illustrated in accordance with the present disclosure. The electricity production system 100 includes a primary solar collector array 102 and a secondary solar collector array 104. Each of the primary and secondary collector arrays is connected to a mobile frame 106 for support. The frame 106 may be made mobile by connection to a trailer capable of being towed by a vehicle. The electricity production system 100 is mobile and may be positioned in a variety of locations and easily relocated when desired. In at least one embodiment the mobile frame includes a trailer hitch 108 and a plurality of wheels 110. In other embodiments, the electricity production system 100 may be integrated as part of a vehicle.

FIGS. 1 through 3 depict the mobile electricity production system 100 in a transport configuration. Both of the primary and secondary collector arrays 102, 104 are collapsed to facilitate transport. In at least one embodiment, the compact size of the transport configuration allows the mobile electricity production system 100 to fit within a standard size freight shipping container. One example of the mobile electricity production system 100 includes an onboard battery bank 140, fuel tank 142, water bladder (not shown), and generator 144. A short version of the mobile electricity production system 100 may be 25 feet long. An extended version of the mobile electricity production system 100 may be 33 feet long. The 25-foot version has a maximum solar output rating of 12.5 KW with standard panels. These standard panels are upgradable to a maximum output rating of 18 KW. Solar panels that are more efficient may enable higher maximum output ratings. The system may weigh about 14,200 pounds without fuel or water. The system may also have a mobile height of 9.5 feet. The height may be lowered to 9.0 feet when stationary by using the trailer hitch 108. These dimensions allow the mobile electricity production system 100 to fit within a 30 or 40 foot intermodal shipping container with a height of 9 feet 6 inches (Hi-Cube) or any other container. This configuration allows the transport of mobile electricity production system 100 with the capability to trailer the mobile electricity production system 100 to and from shipping locations. With this lightweight configuration, the trailer may be pulled using a super-duty truck (e.g., F-250).

Each of the primary and secondary collector arrays 102, 104 includes a plurality of photo-voltaic (“PV”) panels for receiving solar energy and converting it into electrical energy. In the transport configuration, the plurality of PV panels is folded to be stacked over one another in a vertical arrangement proximate to the frame 106. In at least one embodiment each of the primary and secondary collector arrays 102, 104 comprises five PV panels that pivot with respect to one another. Pivoting movement may be provided by hinges 112 positioned between adjacent panels. Each of the solar collector arrays includes a central PV panel and a first pair of PV outer panels pivotally attached to each opposing lateral edge of the central panel. A second pair of PV outer panels is additionally pivotally attached to the outer lateral edges of each of the first pair of PV panels.

The mobile electricity production system 100 has a base geometry 129 that may allow removal from the frame 106 and placement onto an alternative mobile or fixed frame. The base geometry 129 may be set into a modular mounting system. This may allow additional versatility of the electricity production system 100 in that the system is not restricted to the movable trailer. Additionally, the electricity production system 100 may be removed from the fixed modular mounting system and re-attached to a trailer for transport.

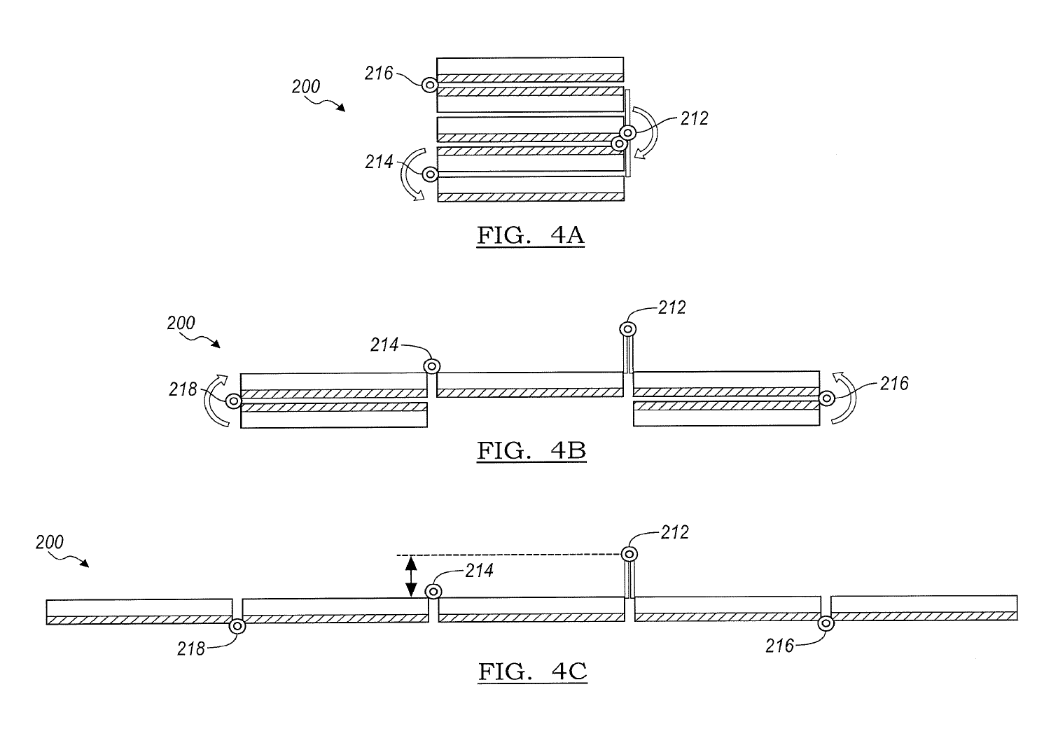

Referring to FIG. 4A-C, a schematic view of the deployment articulation of a panel array 200 is shown in steps A through C. In step A, hinges on opposing lateral edges of the central panel are actuated to unfurl the first pair of PV outer panels. A direction of rotation is indicated by arrows in the figure. A first hinge 212 includes an axis that is offset with respect to a second hinge 214 on the opposing lateral edge of the central panel. The first hinge 212 is actuated before a second hinge 214 to allow clearance for the opposing one of the first pair of PV outer panels to rotate into an unfurled position. In step B, a third hinge 216 and fourth hinge 218 are actuated to unfurl each of the second pair of PV outer panels. It should be appreciated that in the transport configuration, the solar collection side of each of the individual panels faces each other to lessen the risk of damage during transport by shielding the face of solar collection side.

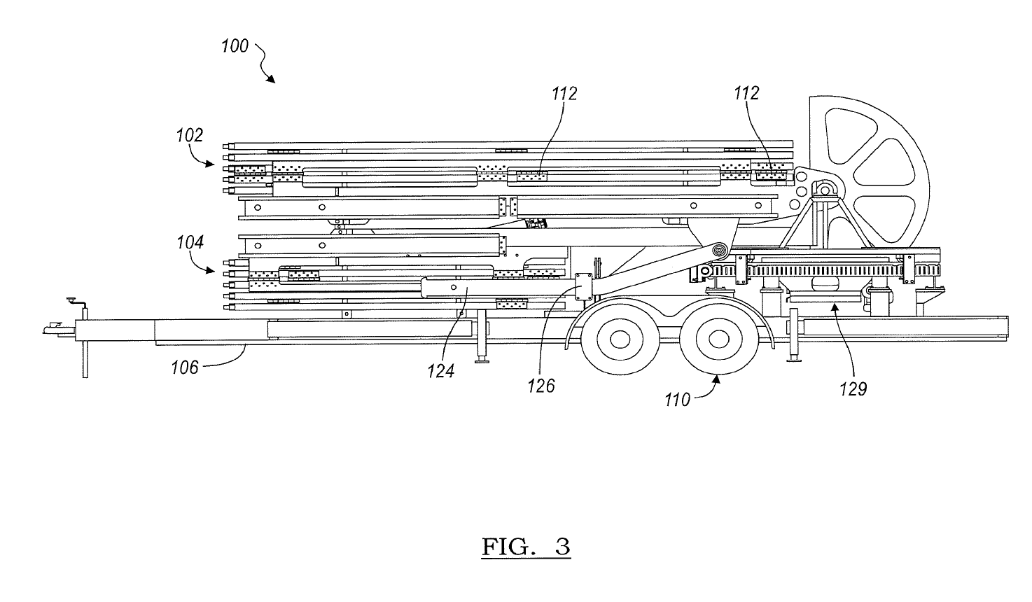

Referring back to FIG. 3, is can be seen that both of the primary solar collector array 102 and the secondary solar collector array 104 are both collapsible and stack vertically relative to one another in the transport configuration.

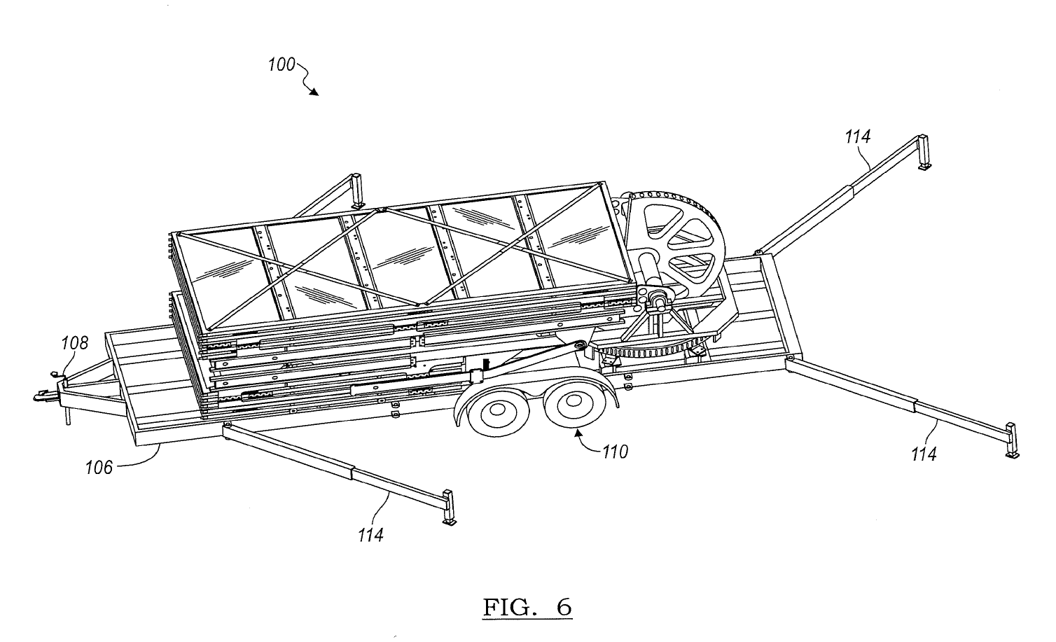

Referring to FIG. 6, the mobile electricity production system 100 may be transported to a desired location for use using the rolling trailer. Once positioned at a desired location, deployment of the collector may begin. In at least one embodiment, pivoting stabilization legs 114 are disposed near each corner of the trailer portion. In the transport configuration, each of the stabilization legs 114 rests flush with a side portion of the trailer frame 106. Each of the stabilization legs 114 may be deployed by pivoting about a respective vertical axis. Also, each stabilization leg 114 includes a telescoping length to maximize leverage by extending the distance between the frame 106 and the ground contact point of each stabilization leg 114.

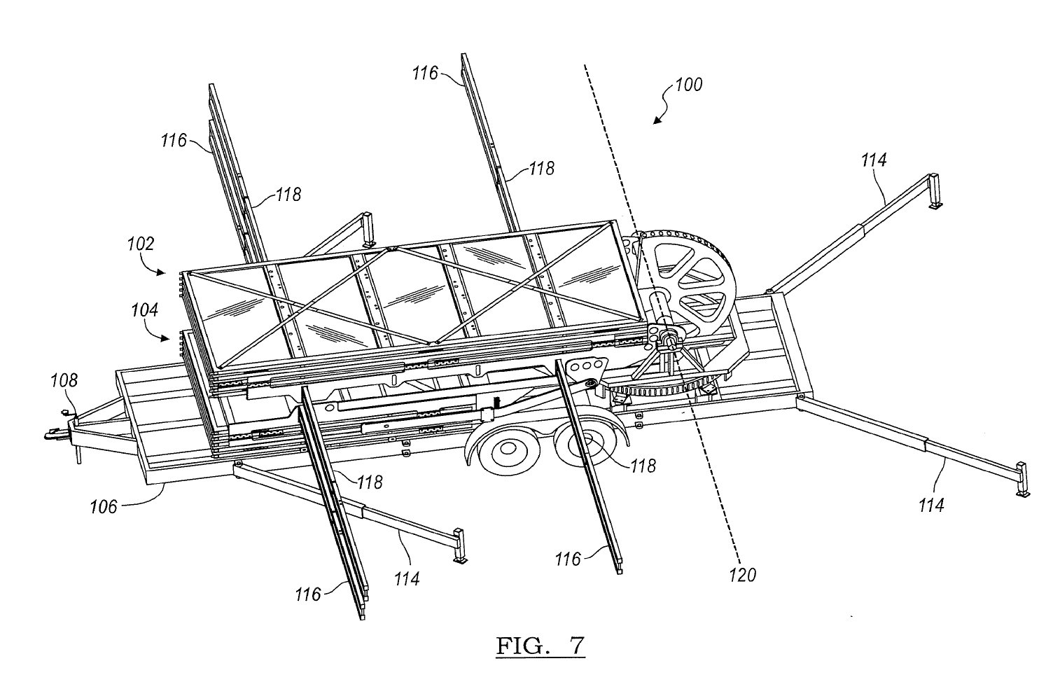

Referring to FIG. 7, once the electricity production system 100 is stably located, elongate support arms 116 are deployed for maintaining the position of the primary solar panel array 112. Each support arm 116 may carry two hinges 118, each with a vertical axis of rotation. In one embodiment, each support arm 116 includes an “I-beam” cross section. In further embodiments, the support arms 116 may comprise a closed cross-section, or other shape suitable to maintain the position of the solar panel array.

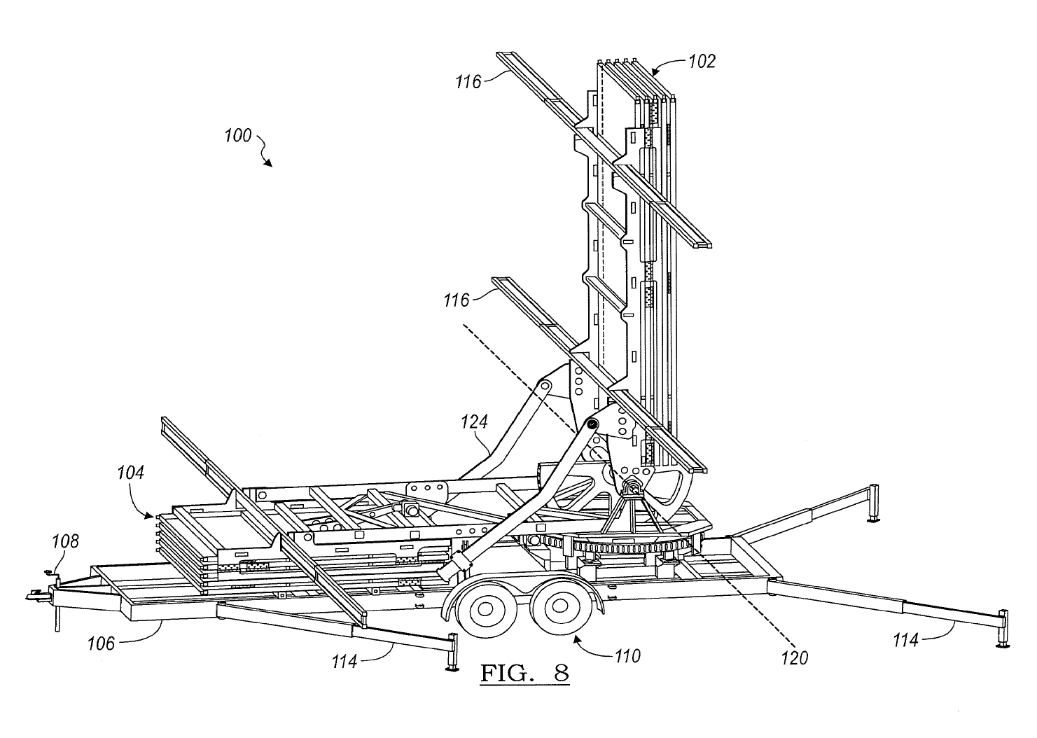

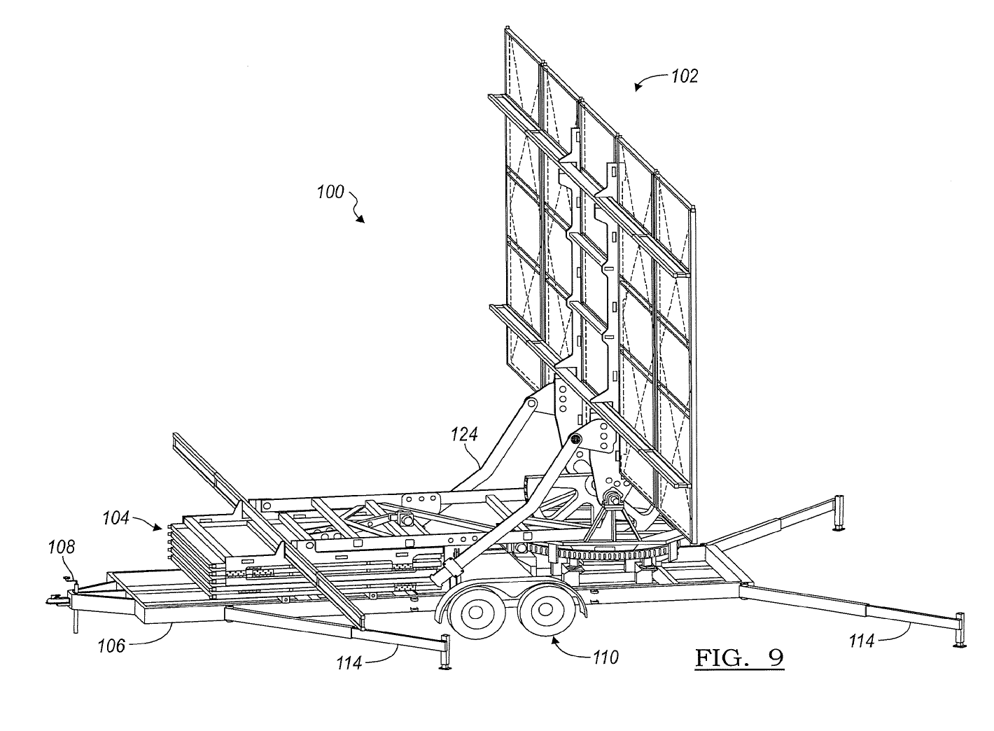

Referring to FIGS. 8 and 9, the primary panel array 102 is rotated about a first horizontal axis 120 near the frame 106 to rotate a pitch of the of the primary collector panel array 102. This rotation of the primary collector array 102 may be provided by a pitch actuation mechanism which is described in more detail below.

The primary solar panel array 102 may be unfurled from the transport configuration after the support arms 116 are deployed. It should be noted that each hinge 112 between the individual collector panels includes a rotation axis that is generally horizontal when in the transport position. Without restricting the motion, it may be difficult for a user to prevent the panels from dropping due to their weight during the process of unfurling the array. To resolve this, the primary collector array 102 may be rotated upward to a generally vertical pitch prior to unfurling the individual collector panels. In this way each of the axes of the hinges 112 between each panel is reoriented to be generally vertical to reduce the gravitational effect upon the panels allowing a single person to easily control the movement of heavy panels and rotate them to the unfurled position.

It should be appreciated that the axes of the pivots 118 of the support arms 116 are oriented in an orthogonal direction with respect to the axes of the hinges 112 between the respective collector panels. The opposing directions of rotation of the collector panels relative to the support arms 116 restrict rotational movement of the collector panels once the panels are secured to the arms 116. Additionally, the locations of pivots 118 of the support arms 116 are offset laterally from the hinges 112 between each of the collector panels. In other words, each of the pivots 118 of the support arms 116 is laterally aligned over a flat portion of one of the collector panels. And, each of the hinges 112 between the individual panels is laterally aligned over a flat unitary portion of a support arm 116. In this way, once the panel array is secured to the support arms 116, any loading upon the panels, for example during wind loading, is distributed through the unitary portions of the support arms 116 as opposed to loading the support arm pivots 118.

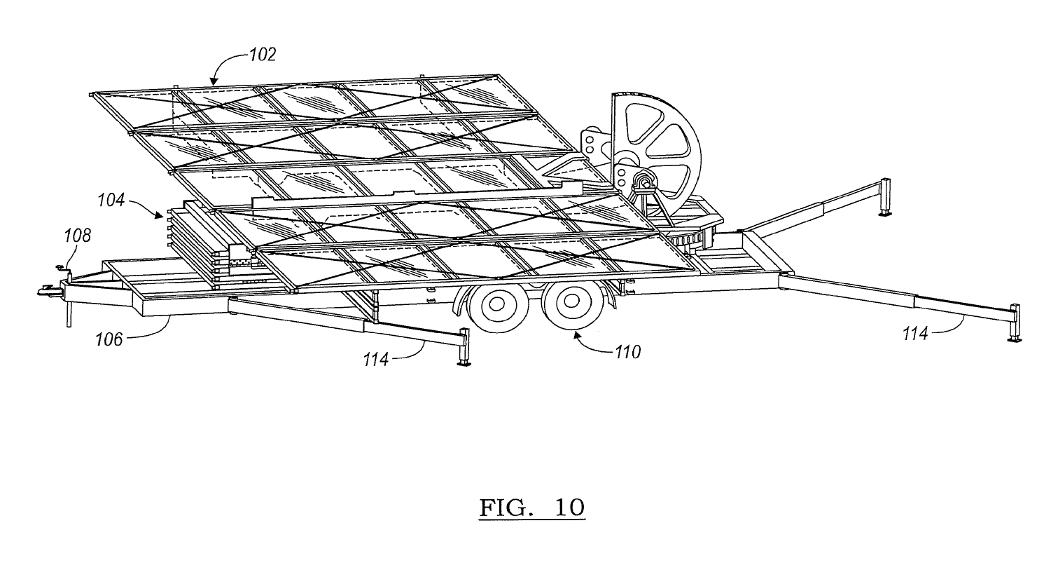

Referring to FIG. 10, the primary collector panel array 102 may be rotated back downward to a generally horizontal position prior to securing the panels to the support arms 116. Two benefits are achieved by securing the panels in this orientation. First, the weight of the panels in a horizontal position biases the panels against the support arms 116 to facilitate a bolted securement. Second, by lowering the height of the panels from the ground allows a single operator on the ground to secure the collector panels to the support arms without the need for tall ladders or other special equipment that may be required to secure the panels in an upright position.

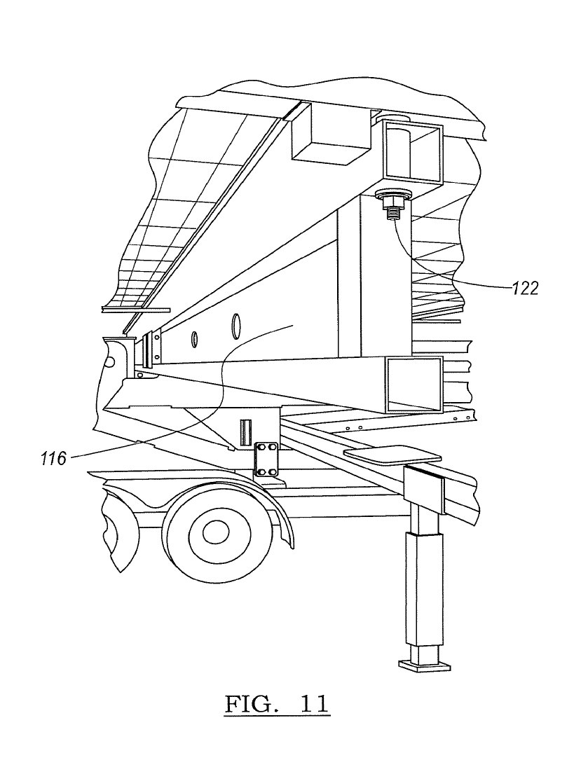

Referring to FIG. 11, a removable fastener 122 extends through a perimeter frame of a collector panel to secure the panel to a support arm. In at least one embodiment, a threaded bolt removably secures the primary collector panel array 102 to the support arms 116. A plurality of bolts may be provided along each support arm 116 to secure the position of each collector panel. While bolts are discussed herein by way of example, a number of different removable fastener types may be suitable to secure the individual panels to the support arms.

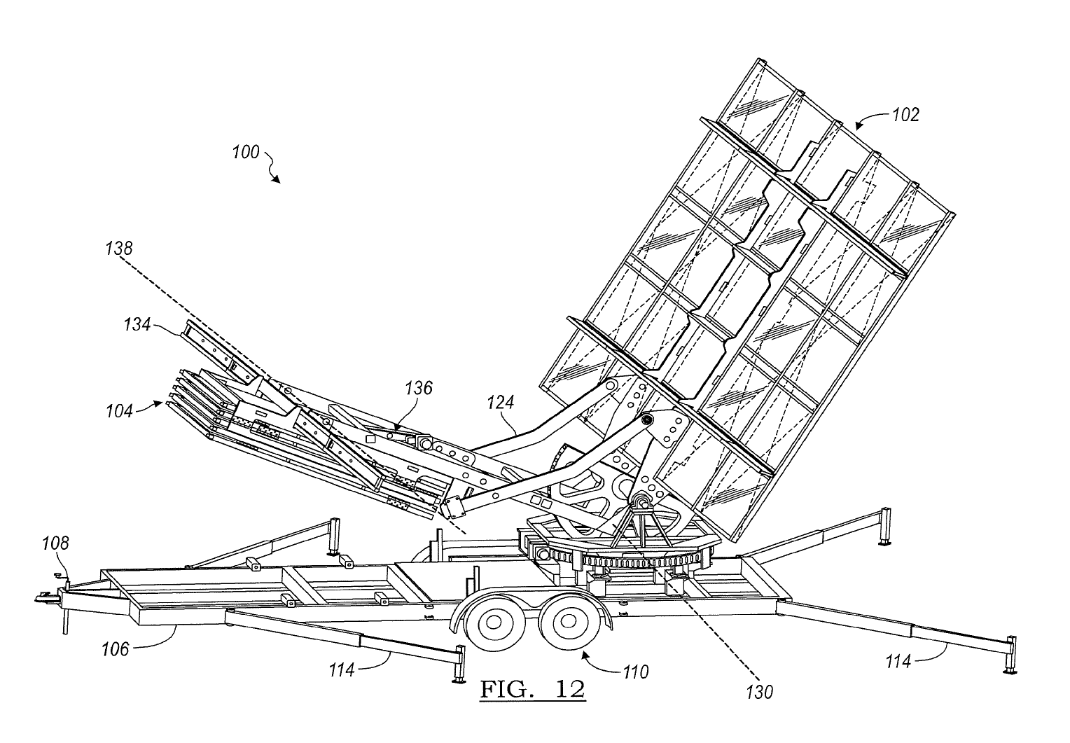

Referring to FIG. 12, the primary panel array is operatively connected to the secondary panel array 104 by a pair of struts 124. As the primary collector panel array 102 is rotated upward about the first horizontal axis 120 near the frame 106, each of the struts 124 slide though a guideway in a slider block 126 that is affixed to the secondary panel array 104. Once the primary panel array 102 is at a predefined pitch angle that is beyond vertical, the struts 124 reach end of travel and a strut stop 128 engages each slider block. The secondary collector array 104 is pivotable about a second horizontal axis 130, and as the primary panel array 102 is further rotated to a reclined pitch angle, the struts 124 begin to lift the secondary panel array 104.

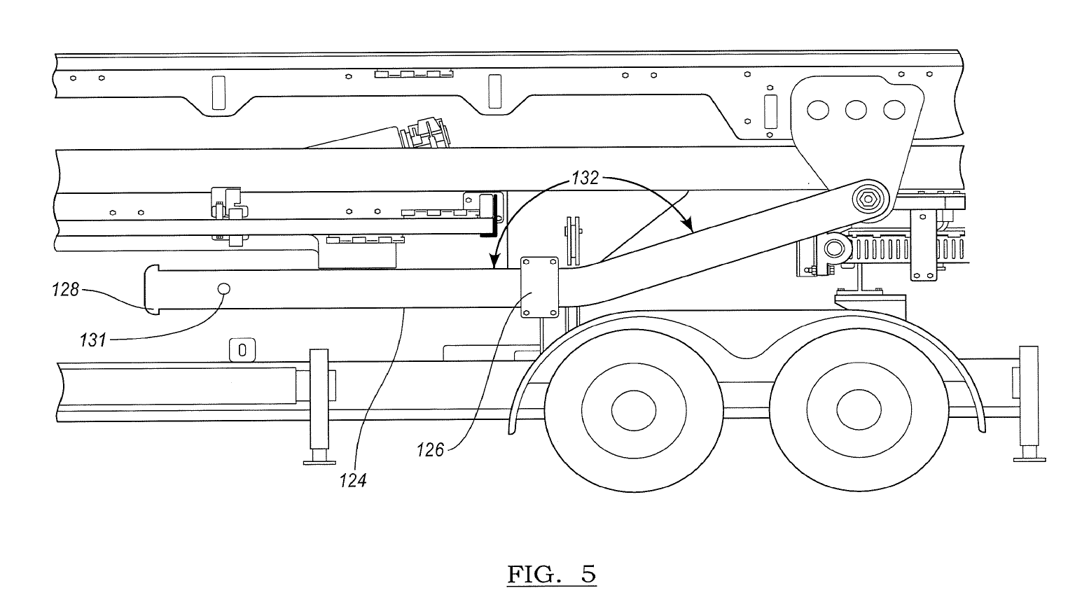

Each of the struts 124 includes an angled profile. Referring specifically to FIG. 5, it can be seen that the angled profile 132 of the struts 124 allows for a lower overall height of the mobile electricity production system 100 while in the transport configuration. Without such an angled profile 132, vertical clearance from the strut stop to the ground would be reduced and possibly create an interference condition. The height of the mechanism would therefore need to be increased to avoid this interference between the strut stops 128 and the ground. By providing an angled profile 132 on each of the strut arms 124, a more compact configuration may be achieved having greater package efficiency. The lower height additionally facilitates shipping the entire mobile electricity production system 100 within a standard-sized freight container as discussed above. In at least one embodiment, an angle bend of about 18.5 degrees is provided on each of the struts 124. It is contemplated that a range of different angles may be suitable depending on the particular orientation and size of the relative components of the mechanism.

Each of the struts 124 define a hole 131. The holes 131 are paired with retractable pins on the frame (not shown). The pins engage the holes 131 when the holes are aligned to the pin to ensure the primary solar collector array 102 remains locked at an extended position. In at least one embodiment, the pins operate as a safety release and may be automatically or manually retracted prior to lowering the primary solar collector panel array.

Referring back to FIG. 12, the primary solar collector panel array 102 is rotated back to a sufficiently reclined pitch angle to lift the secondary panel array 104 high enough to provide sufficient clearance to unfurl the individual panels of the secondary collector panel array 104. Much like the primary collector panel array 102, support arms 134 are pivoted to a deployed position prior to unfurling the collector panels. Also like the primary collector panel array 102, the support arms 134 rotate about axes which are orthogonal with respect to the rotation axes of the secondary collector panel hinges.

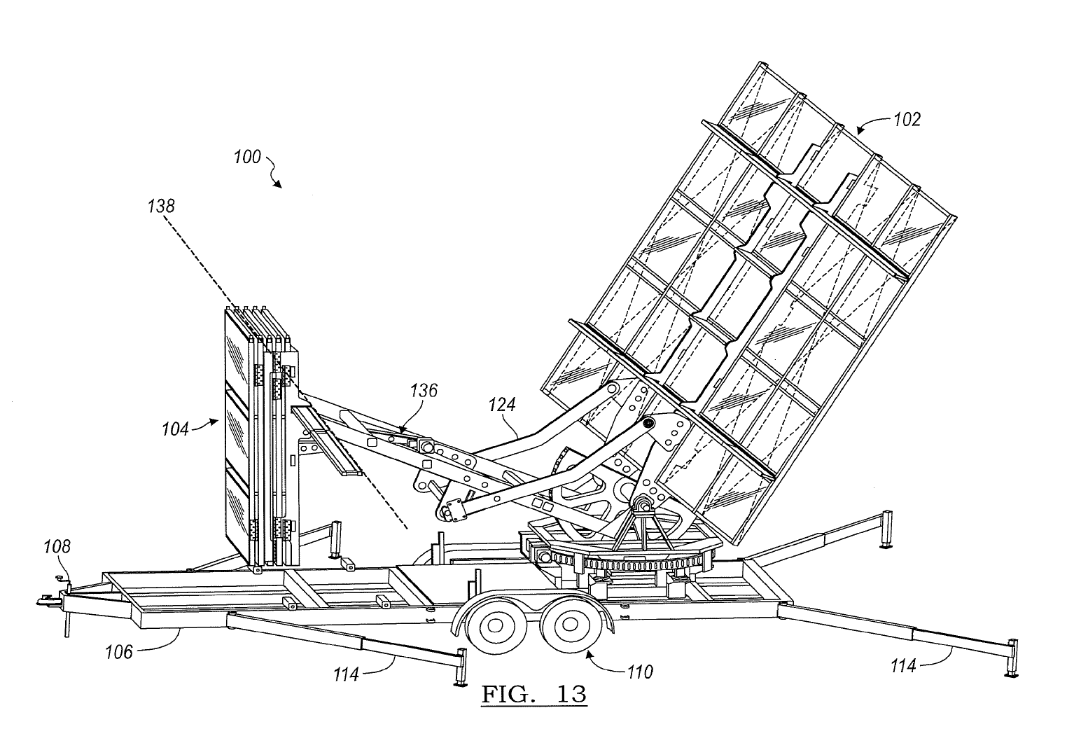

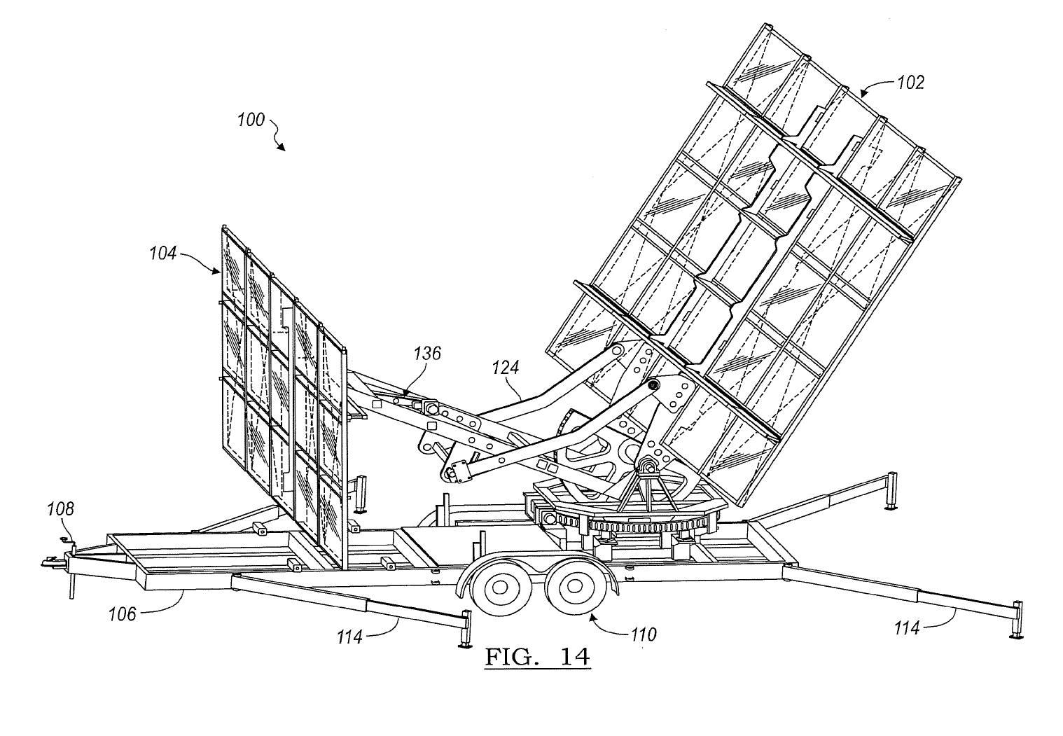

Referring to FIGS. 13 and 14, the secondary solar collector panel array 104 includes a second pitch adjustment mechanism 136 allowing for rotation of the secondary collector panel array 104 about a third horizontal axis 138. The pitch rotation of the secondary collector panel array 104 about the third horizontal axis 138 is independent of the primary collector panel array 102. Related to the weight of the panels and the ease of unfurling the array, the secondary collector panel array 104 is also rotated to a generally vertical orientation such that the rotation axis of each of the hinges between the individual panels is vertical. This orientation relieves much of the gravitational effects on the hinges between panels and allows a user to easily unfurl the panels without risk of damaging the panels from falling open due to gravity.

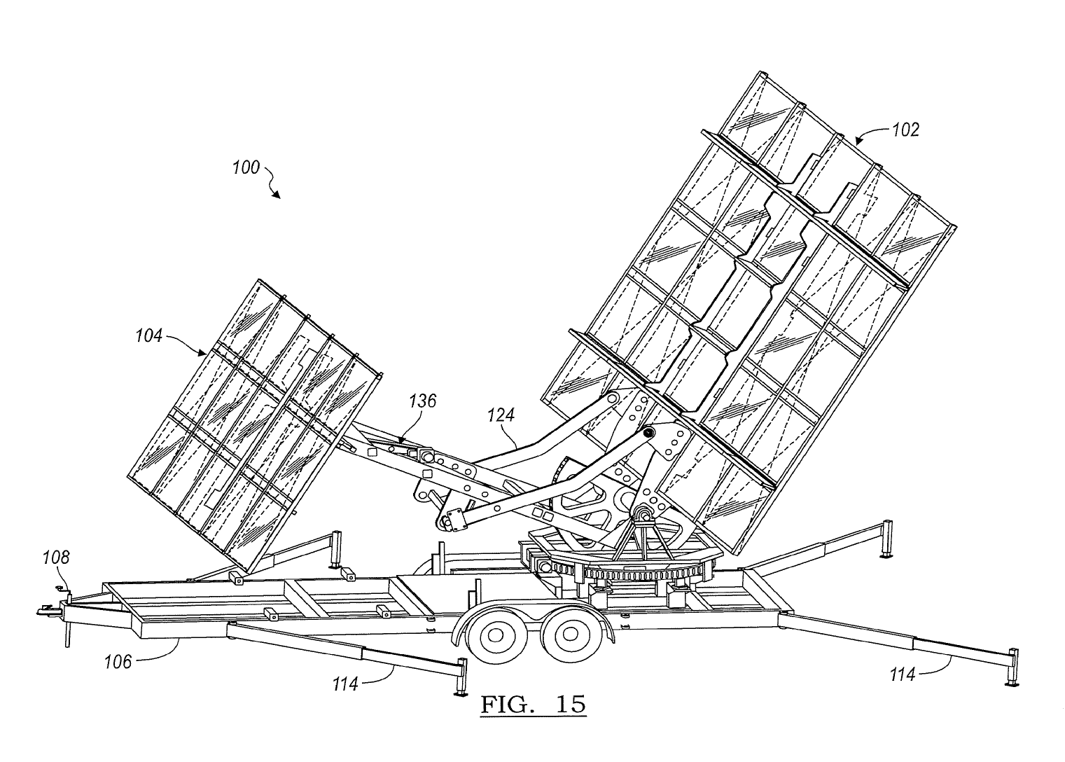

Referring to FIG. 15, the secondary solar collector panel array 104 is reclined to a rearward pitch so that gravity biases the individual panels of the secondary collector 104 against the support arms 134. This facilitates securing of the panels to the support arms 134. Also, the orientation allows a user on the ground to have easy access to the securing locations located on a back portion of the secondary collector panel array 104. Similar to the discussion of above with respect to the primary collector panel array 102, a plurality of removable fasteners are provided to secure the individual panels to the support arms 134.

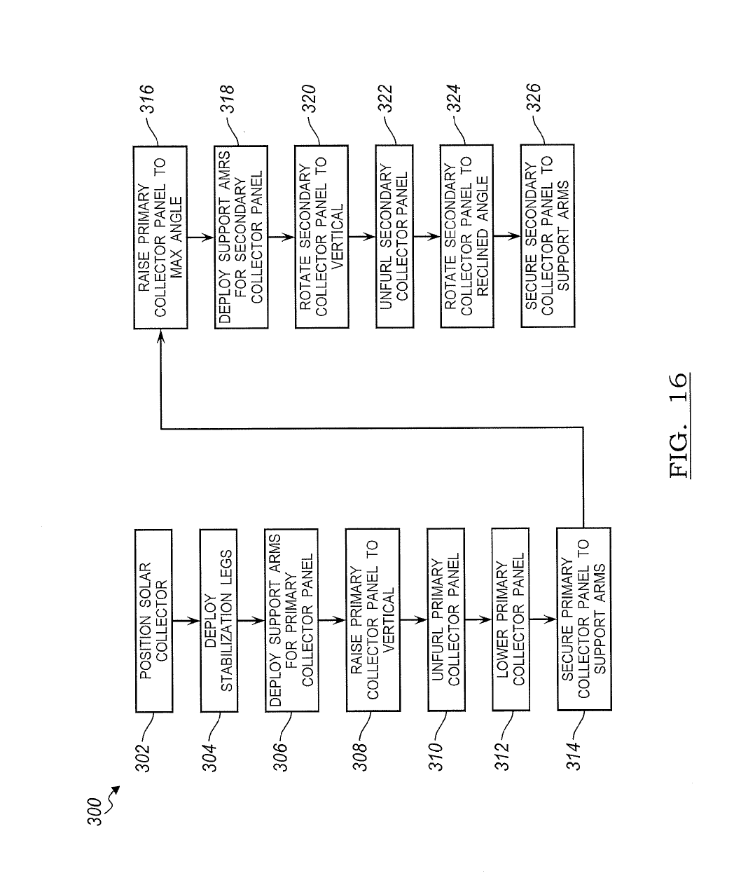

FIG. 16 is a flowchart indicating a method 300 of unfurling a mobile solar collector assembly as described above.

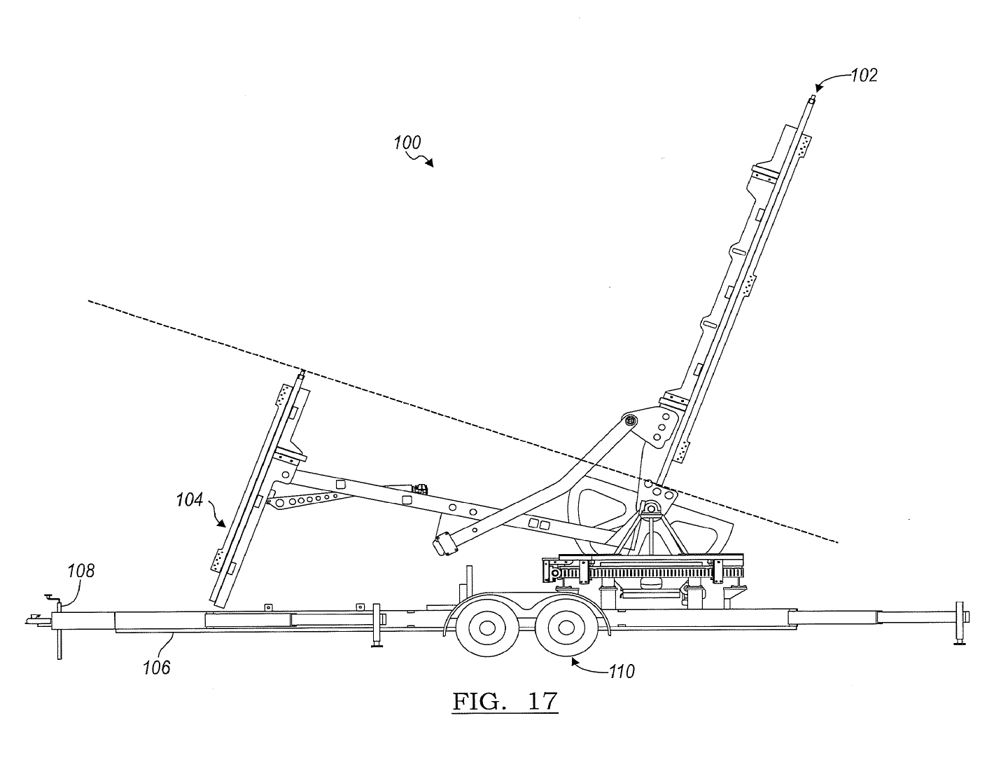

Referring to FIG. 17, once both of the primary solar collector panel array 102 and the secondary solar collector panel array 104 are fully deployed and secured, there is a staggered relationship between the arrays. This staggered arrangement minimizes light blockage of one panel with respect to the other. In at least one embodiment, the secondary panel array 104 is arranged beneath the primary collector panel array 102. Once fully deployed, the total surface area of the collector panel array is about 950 square feet when mounted on the portable trailer. A ground-mount specific version may be about 1400 square feet.

Once the panel arrays are fully deployed and secured, both arrays may be moved as a fixed unit such that pitch and rotation about the main portion of the frame 106 may be adjusted. Based on the cantilevered extension of the secondary collector panel 104 from the pivoting location, its mass operates as a counterbalance to larger the mass of the primary collector panel array 102. This counterbalancing effect reduces loads on the adjustment mechanisms when the panels are reclined to a rearward pitch. Counterbalancing may also help to prolong the service life of the mechanisms related to the reduced loads.

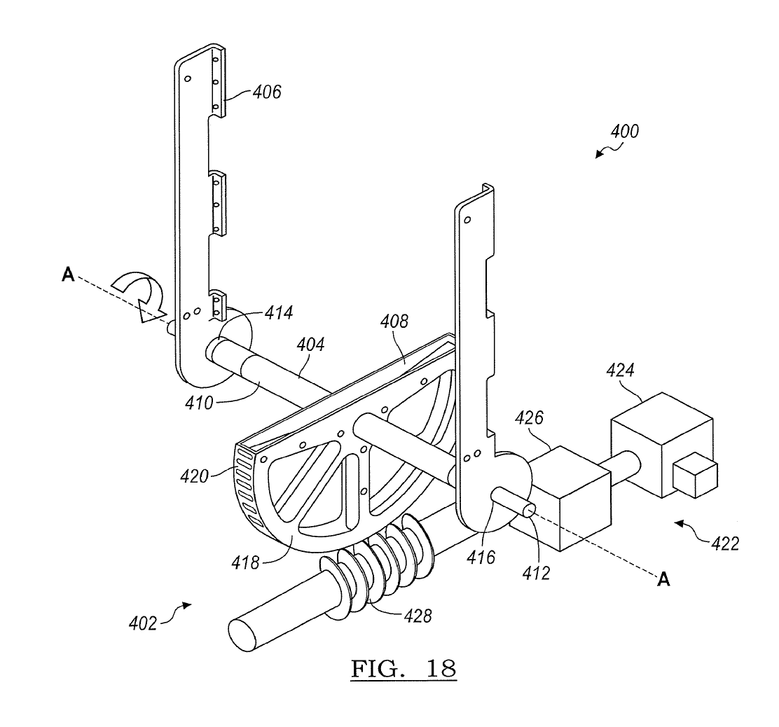

Referring to FIG. 18, a schematic drawing depicts a pitch adjustment mechanism 400 according to an embodiment. A pitch gear assembly 402 is provided for adjusting an elevation or pitch of the primary and secondary collector panel arrays about a horizontal axis A-A. The pitch gear assembly 402 includes a transverse axle 404, a pair of panel brackets 406, and a sector 408 coupled to each other.

The transverse axle 404 provides the horizontal axis A-A for the primary and secondary collector panel arrays to pivot about. The transverse axle 404 includes a tube 410 and a pair of axlerods 412 coupled to one another. The axlerods 412 and the tube 410 are aligned coaxially, such that the axlerods 412 extend from opposing ends of the tube 410. The axlerods 412 have an outer diameter that is smaller than the outer diameter of the tube 410, thereby forming a shoulder 414.

Panel brackets 403 extend from the transverse axle 404 for supporting the primary collector panel array. Each panel bracket 406 includes a rod aperture, for receiving an axlerod. The rod apertures 416 are sized smaller than the outer diameter of the tube 410, such that each panel bracket 406 abuts a corresponding shoulder 414. The panel brackets 406 are aligned with each other and fixed to the transverse axle 404. The brackets 406 are coupled to the central panel at opposing lateral edges for supporting the primary collector panel array.

The sector 408 receives mechanical power for adjusting the pitch of the primary and secondary collector panel arrays. The sector 408 includes a pair of partially circular gear plates 418, a series of ribs and a slotted plate 420 coupled to each other. Each gear plate 418 includes a central aperture sized for receiving the transverse axle. The series of ribs are positioned between the gear plates 418, for connecting the plates to each other. The ribs radially extend from the central apertures. The slotted plate 420 is disposed over a curved portion of a perimeter of the gear plates 418, thereby further connecting the gear plates 418 to each other. The slotted plate 420 of the depicted embodiment acts as gear teeth. The sector 408 is axially aligned about a mid-portion of a length of the transverse axle 404. The sector 408 is rotationally oriented about the transverse axle 404 such that a flat non geared/slotted portion of the sector 408 is perpendicular to a length of the brackets 406. In one embodiment, the sector 408 is welded to the transverse axle 404 about the central aperture. In another embodiment, a plate (not shown) is fastened to the sector 408. The plate may include an aperture for receiving the transverse axle 404, and allows for removal of the sector 408 for maintenance.

A pitch actuator 422 engages the pitch gear assembly 402 for adjusting the elevation or pitch of the primary and secondary collector panel arrays. The pitch actuator 422 rotates the primary collector panel array about the transverse axle 404. The pitch actuator 422 is mounted tangentially to the sector 408 at a central portion of the frame. The pitch actuator 422 includes a pitch motor 424, a pitch reduction gear train 426 and a pitch worm 428 operatively coupled to one another. The pitch motor 424 may be an AC or DC motor, configured for receiving electrical power from a battery, generator, or other power source (not shown) and converting it into mechanical rotational power. The reduction gear train 426 is coupled to the output of the motor 424. The reduction gear train 426 is sized for increasing the output torque of the motor 424. The pitch worm 428 is coupled to the output of the reduction gear train 426. The worm 428 is configured for meshing with the slotted plate 420 of the sector 408. The worm 428 is also configured to be self-locking, such that torque applied to the worm 428 cannot back-drive the pitch motor 424. Additionally, a gear housing (not shown) may be provided for enclosing the worm 428 and preventing particles (e.g., dirt, debris) from collecting in the gear mesh.

The pitch actuator includes a pitch sensor (e.g., a potentiometer, encoder, hall-effect sensor, etc.) for indicating the position and/or speed of the pitch actuator, which corresponds to a position (altitude angle) of the primary collector panel array. In one embodiment of a mobile solar collector, an encoder is coupled to the motor for measuring output angular travel.

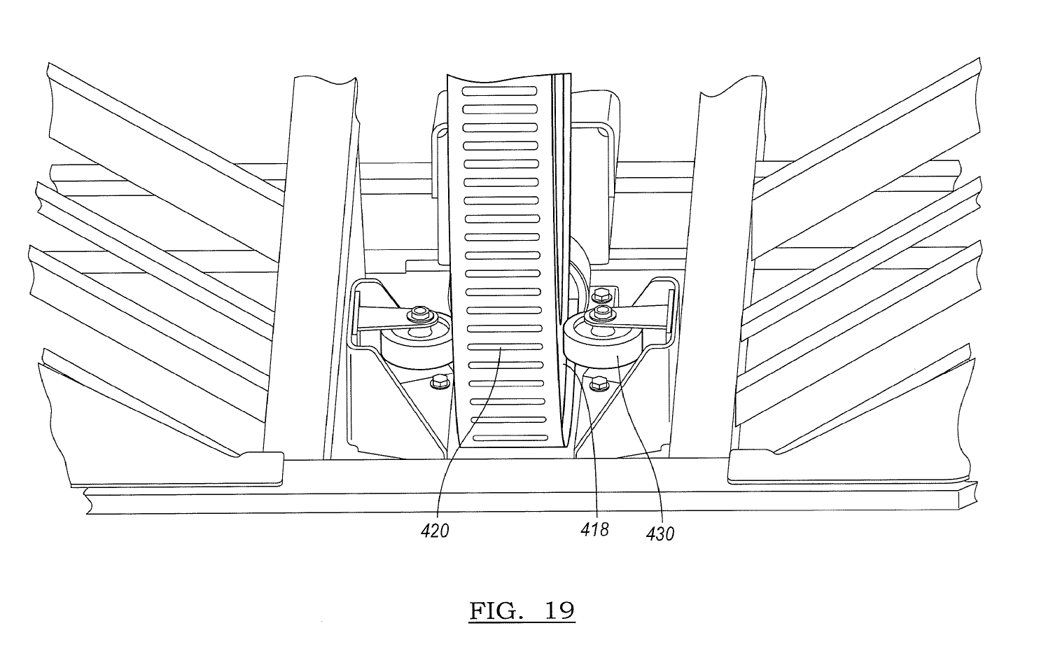

Referring to FIG. 19, lateral stabilizers 430 interface with the gear plates 418 from opposing sides. The lateral stabilizers 430 may operate to maintain precise alignment of the gear plates 418 with respect to the worm 428. In one embodiment, a pair of opposing rollers guides the sector 408 near the contact point with the worm 428. In alternative embodiments, slider blocks or other fixed guide features may be sufficient to stabilize the sector 408.

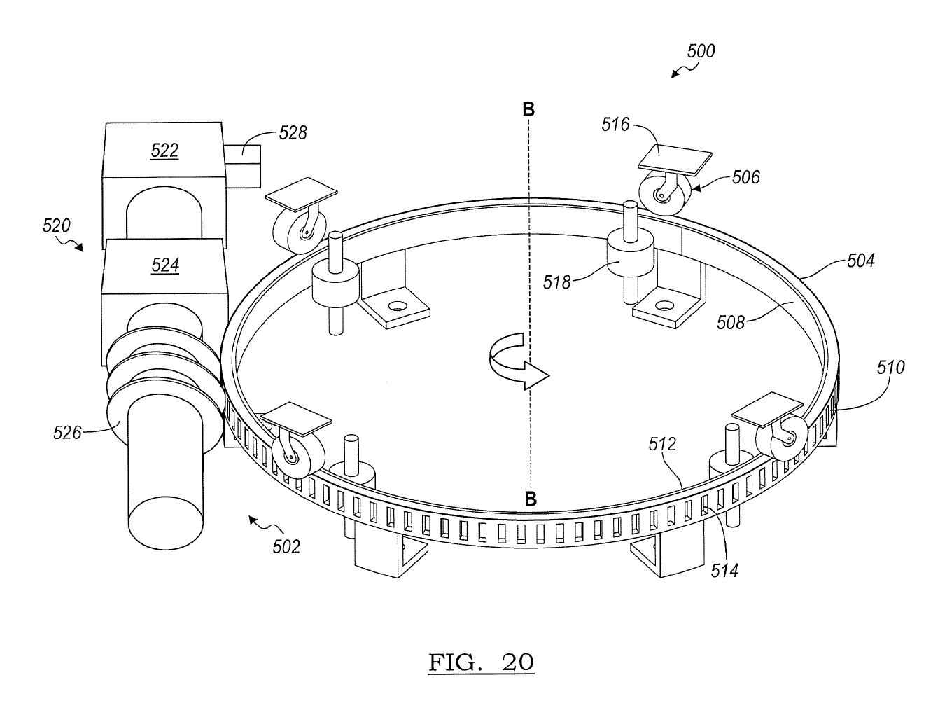

Referring to FIG. 20, a rotation adjustment mechanism 500 is provided for adjusting a rotational position of the primary and secondary collector panel arrays about a vertical axis B-B. A rotation gear assembly 502 includes a gear wheel 504 and a bearing assembly 506 operatively coupled to one another.

The gear wheel 504 is mounted upon the trailer 106 in a generally horizontal orientation. The gear wheel 504 includes a channeled tube 508, a slotted plate 510 and a rod 512 that are coupled to each other and formed into a ring. The channeled tube 508 is formed of an elongate partially enclosed tube. In one embodiment of the rotation gear assembly 502, the channeled tube 508 is formed using “C-Channel” tubing. The slotted plate 510 is formed of an elongate sheet of material. A series of slots 514 project through plate. The series of slots 514 are longitudinally spaced along a length of the slotted plate 510. The slotted plate 510 is disposed over the channeled tube 508, thereby forming an enclosed cavity within the tube 508. The slotted plate 510 is oriented about a circumference of the ring with the slots 514 facing outward. The slots 514 in the depicted embodiment operate as gear teeth. The rod 512 is disposed upon an upper portion of the channeled tube 508 about a perimeter of the ring for engaging the bearing assembly 506. Other embodiments of the rotation gear assembly 502 may include a unitary gear wheel, (e.g., a die cast or molded gear wheel).

The bearing assembly 506 provides a low friction interface during rotational adjustment. The primary and secondary collector panel arrays are coupled to the frame 106, and the bearing assembly 506 couples the frame 106 to the gear wheel. The bearing assembly 506 includes a series of casters 516 and a series of roller bearings 518 cooperating with each other. The casters 516 are mounted to the frame 106 and support the gear wheel 504. In one embodiment of the mobile electricity production system, the casters 516 engage the rod. The roller bearings 518 are mounted to the frame 106 and are configured for engaging an inner diameter of the gear wheel 504. A bracket may extend from the frame 106, and wrap around the outer diameter of the gear wheel 504, further securing the frame 106 to the gear wheel during high eccentric loading. The roller bearings 518 also help maintain a radial alignment of the frame 106 relative to the gear wheel 504.

A rotation actuator 520 engages the rotation gear assembly 502 for adjusting the rotational position of the primary collector panel array and secondary collector panel array. The rotation actuator 520 is mounted tangentially to the gear wheel 504, upon a plate which extends downward from the frame. The rotation actuator 520 includes a rotation motor 522, a rotation reduction gear train 524 and a rotation worm 526 operatively coupled to one another. The rotation motor 522 may be an AC or DC motor, configured for receiving electrical power from a battery, generator, or other power source (not shown) and converting it into mechanical rotational power. The reduction gear train 524 is coupled to the output of the motor 522. The reduction gear train 524 is sized for increasing the output torque of the motor 522. The rotation worm 526 is coupled to the output of the reduction gear train 524. The worm 526 is configured for meshing with the slotted plate 510 of the gear wheel 504. The worm 526 is also configured to be self-locking, such that torque applied to the worm 526 cannot back-drive the rotation motor 522. Additionally, a gear housing (not shown) may be provided for enclosing the worm 526 and preventing particles (e.g., dirt, debris) from collecting in the gear mesh.

The rotation actuator 520 includes a rotational position sensor 528 (e.g., a potentiometer, encoder, hall-effect sensor, etc.) for indicating the position and/or speed of the rotation actuator 520, which corresponds to a position of the primary and secondary collector panel arrays. In one embodiment of the mobile electricity production system, an encoder is coupled to the motor 522 for measuring output angular travel. Alternate embodiments of the electricity production system may include a sensor coupled to the primary and secondary collector panel arrays for indicating the angular position of the solar panels.

In one embodiment of the mobile electricity production system, an adjustable satellite dish is mounted to the trailer. The dish may be configured for communicating with a satellite (not shown). The satellite dish may further be used to receive remote operation commands, or receive broadcast information such as weather conditions and forecasts. The dish may include separate adjustment actuators for adjusting the position (rotation and yaw) of the dish to relative to the satellite. The dish may further communicate with a global positioning system satellite to monitor a location of the mobile solar collector. In this way, the position of the sun throughout a given day may be known in advance based upon the geographic location and the time of the year. This predetermined data may help to adjust the orientation of the primary and secondary collector arrays throughout the day to track the sun and obtain optimal solar input to the collector panels. Additionally, weather information may be received at the mobile electricity production system such that the panels may be articulated from the deployed configuration before severe weather arrives at the location of the mobile electricity production system in order to avoid damage cause by weather.

The mobile electricity production system has several different configurations as discussed above. The travel configuration includes each of the panel arrays fully collapsed and the trailer arranged for easy transport. Also described above, the fully deployed configuration includes that both panels are unfurled and articulable to track the sun for optimal solar collection. There is also a sleep configuration where both collector panel arrays are unfurled, but each is rotated forward to a lowermost pitch. The sleep configuration is useful during several different scenarios. First, rotating the panels fully downward allows for easy cleaning of the panels by a single person on the ground with hand cleaning equipment. This configuration avoids the need for ladders or complex cleaning equipment. Also, servicing of panels, wiring, or other componentry can be performed at a ground level. Additionally, the sleep configuration may be employed during high wind loading conditions to avoid damage to the mobile solar collector due to severe weather. Further, the sleep configuration may be employed at night while there is no solar collection occurring. Since the panels are oriented with the collection side down, the sleep configuration helps to reduce accumulation of debris from the environment upon the collection side of the collection panel arrays.

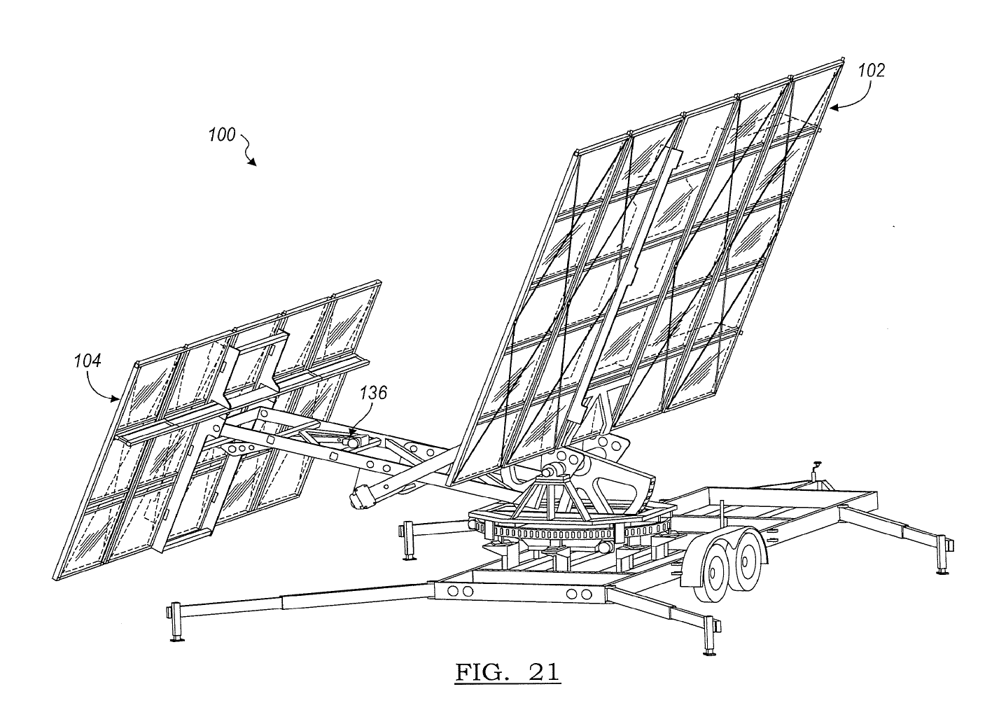

Referring to FIG. 21, the mounting side of the panels provides usable area for other features which add value beyond solar collection. In one embodiment, displays, banners, or other advertisement materials are mounted to the backside of the primary and secondary collection panel arrays. The displays may include screens, lighting, or other varying optical effects such that users may view the materials when the collector arrays face an opposing direction. In such a case, a user may desire to maintain the mobile solar collector in a fully deployed configuration at night to take advantage of illuminated advertising areas. Additionally, other features and devices may be mounted to the backside of the collector panel arrays. In other embodiments, at least one of a video camera and a loud speaker is mounted near the top of the central panel.

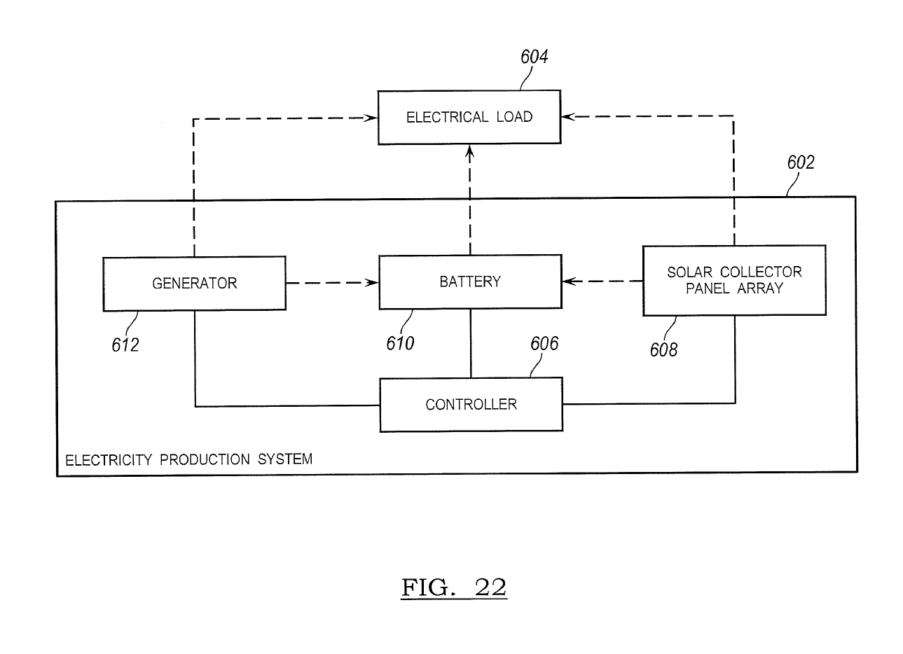

FIG. 22 is a system schematic of a mobile electricity production system 602 depicting the power exchange between a solar collector panel array 608, a battery 610, and a generator 612. The mobile electric supply system is coupled to an electrical load 604. The mobile electric supply system 602 may be provided with one or more power outlets to allow a user to electrically connect a device to be powered. In at least one embodiment, a petrol generator 612 is provided as part of the mobile solar collector to generate power from the burning of fossil fuel. The solar collector panel arrays 608 may provide harvested solar energy. A battery 610 is provided as part of the mobile electricity production system 602 to store energy that is either generated by the generator 612, back-fed from the power grid, or collected from the solar collector panel arrays 608. A controller 606 is also provided as part of the mobile electricity production system 602 to control the function of the generator 612, battery 610, and solar collector panel arrays 608. The controller 606 is in communication with each of the devices to read inputs indicative of power input and output, state of charge, solar collector panel array 608 orientation as well as other attributes. Similarly, the controller 606 is programmed to issue command signals to each of the devices to determine timing of operation and direction of power flow. Various scenarios influencing the power flow may be described in more detail below.

Although it is shown as a single controller 606, the controller 606 can include multiple controllers that are used to control multiple systems. For example, the controller can be a system controller. In this regard, the charging control portion of the system controller can be software embedded within the system controller, or it can be a separate hardware device. The controller generally includes any number of microprocessors, ASICs, ICs, memory (e.g., FLASH, ROM, RAM, EPROM and/or EEPROM) and software code to co-act with one another to perform a series of operations. A microprocessor within the controller further includes a timer to track elapsed time intervals between a time reference and selected events. Designated intervals are programmed such that the controller 606 provides commands signals and monitors given inputs at selectable time intervals. The controller is in electrical communication with the battery 610, solar collector panel array 608, and generator 612 and receives signals that indicate the battery charge level. The controller 606 may also further communicate with other controllers over a hardline or wireless connection using a common protocol (e.g., CAN, 802.11).

The generator system may also similarly have its own control system used to govern the rotor speed and output of the generator. The battery may also have separate contacts and power regulation to regulate recharging current and voltage or regulate output current. Likewise, the solar collector panel array 608 may include its own control system (not shown) to monitor solar power collected, and manage articulation of the solar collector arrays as discussed above.

The controller obtains information from a sensor indicative of the amount of sunlight available. When the received solar energy is above 70 W/m², the controller may issue a command to deploy the solar collector panel array 608 by communicating with the solar energy collector controller (not shown). The system may then undergo a “wake up” procedure where the mobile collector automatically articulates from the sleep configuration to the deployed configuration in response to the presence of sufficient sunlight.

The controller may also determine whether there is an electrical load present. In at least one embodiment, the controller 606 determines the presence of an electrical load 604 by using a small power source such as a capacitor. If there is an active load, the power source may be depleted if an electrical load 604 is present. In other embodiments, the controller 606 may determine the presence of a load is using visual sensors. In further embodiments, the controller 606 determines the presence of a load based on user input.

When no electrical load is present, any electrical energy generated by the solar collector panel array 608 may be used to recharge the battery 610. A battery charge controller (not shown) may be used to determine the state of charge (SOC) of the battery 610. In at least one embodiment, the battery 610 is considered at maximum SOC when the battery 610 is fully charged. The battery 610 may also be considered fully charged when SOC is about 85-100%. The maximum SOC threshold may be adjusted depending on whether the solar collector panel array 608 or the generator 612 is providing power. If the generator 612 is charging the battery, the controller 606 may be configured to charge the battery 610 to a level less than absolute maximum in order to conserve the burning of fossil fuels. This level may be set at 75-85% of the absolute maximum charge. A preferred setting is 80%. With this alternative setting the controller 606 may still allow for the solar collector panel array 608 to charge the battery 610 to the absolute maximum charge or a level about 85-100%.

These contrasting charge thresholds may be adjusted based on anticipated sun load (ASL) or anticipated conditions. The thresholds may be adjusted based on projected conditions such as time of day, weather, and date. In at least one embodiment, the controller 606 may be aware that the sun rises at 7:00 AM. If there is a need to start the generator 612 based on the electrical load 604 at 2:00 AM, the generator may recharge the battery at the same time. If the need is still present at 6:00 AM and the battery 610 is at 75%, the controller 606 may calculate the projected consumption of electricity and determine that the battery may satisfy the electrical load 604 independently. In this configuration, the battery 610 may provide power from 6:00 AM to 7:00 AM, and the solar collector panel array 608 may recharge the battery 610 and provide power to the load 604 when the sun rises at 7:00 AM.

Another usage that may be automatically or manually applied is the day of the week maximum battery 610 charge threshold adjustment. The thresholds may be adjusted if the controller 606 determines empirically that the electricity production system 602 is not used on the weekends. The controller 606 may also be set to signify the system will not be used on the upcoming weekend. This would allow the controller 606 to dynamically adjust the maximum charge threshold when the generator 612 is in use. If the controller 606 can determine, based on weather data and non-use, that the solar collector panel array 608 can recharge the batteries 610 over the weekend, the controller 606 may lower the maximum charge threshold and stop use of the generator 612.

These schemes may be used to adequately supply the load whether the anticipated circumstances are time of day, history of use, weather forecasts, day of the week, projected locations of the electricity production system 602, or any other anticipated circumstances that would allow the use of the generator 612 or battery 610 to be decreased.

The battery 610 may be considered at low SOC when the battery 610 is about 30-60% SOC and preferably 55%. In at least one embodiment, the battery 610 is considered at a critical SOC when the battery 610 charge is about 5-10% SOC and preferably 10%. Similar to the dynamic maximum charge threshold and the low SOC threshold, the critical SOC value may be dynamically adjusted to meet anticipated sun load and anticipated conditions. The battery type used may have a suggested maximum charge value to prolong the life of the battery 610, by avoiding overcharging of the battery 610. The battery controller may communicate with the system controller whether the SOC of the battery 610 is sufficiently low to require recharging, or sufficiently charged to allow energy depletion. When sufficient power is available, the battery 610 is recharged until the SOC reaches a predetermined maximum SOC threshold.

In further embodiments the low SOC threshold is varied based on an anticipated sun load (ASL) in the near future. For example, if it is anticipated that a large amount of solar power will be available shortly, the low SOC threshold may be lowered to discharge the battery 610 deeper to avoid starting the generator 612. This strategy operates to minimize usage of the generator 612 and petrol fuel waste. The value of ASL can be based on one or more factors, for example: (i) current sun load, (ii) average sun load over the previous time period t, (iii) time of day and calendar, and (iv) weather reports. Additionally, the low SOC threshold may be varied based on expected user demands. For example users may input an operation schedule indicating planned usage. Alternatively, the controller 606 may be programmed to make future usage estimates based on historical load patterns. In this way the usage of the generator 612 may be further lessened while supplying energy needs of the electrical load 604.

Electricity generated by the solar collector panel array 608 that is not consumed by the electrical load 604 may be directed to the battery 610 for recharging and storage as discussed above. A challenge is presented in determining whether the solar collector panel arrays 608 are providing the maximum available power, or providing the amount required by the load. In order to solve this challenge, a solar detector can assign typical output values for the solar array based on the incoming flux of sunlight. The controller 606 can then compare the anticipated solar collector panel array 608 output values to the actual solar collector panel array 608 output values. If the values are similar, then the control system can assume that the power delivered by the solar collector panel array 608 is the maximum the panels can provide. If the power provided is insufficient to supply the electrical load 604, the controller 606 may connect and operate the generator 612 and/or draw energy from the battery 610. When there is excess power available from the solar collector panel array 608 array beyond that required by the electrical load 604, the controller 606 may recharge the battery 610 to store the energy.

If there is not enough sunlight to warrant opening the solar collector panel array 608 then the controller 606 may either put the solar collector panel array 608 in a sleep configuration or maintain the solar collector panel array 608 in a collecting configuration. If there is an electrical load 604 as determined by the methods discussed above or otherwise, the controller 606 may start the generator 612 if the battery SOC is less than critical. In at least one embodiment the critical SOC threshold is set to about 5-10% charge.

In another application, the solar collector panel array 608 may not generate enough power to meet the required electrical load 604 and the battery 610 may be depleted to the point where it is not advantageous to use the battery 610 as an electric source. This may occur, for example, during low sun conditions or at night. In this situation, the controller 606 may issue a command to start the generator 612. The generator 612 may then provide additional power up to its maximum capacity. If the battery SOC is also below the critical value and there is excess power available, the battery 610 may be recharged using power delivered by the generator 612. Otherwise, the controller 606 may ensure the electrical load 604 is met and allow the battery 610 to remain at its current charge state.

Although one preferred battery type is lithium-ion, many different battery types may be used for this application. Considered battery types include but are not limited to: zinc-carbon acid, alkaline, lithium, lead-acid, lithium iron phosphate, lithium polonium, nickel metal hydride, nickel-iron, and nickel cadmium.

The solar collector panel array 608 system may also include circuit breakers to protect from overcurrent or overpower circumstances. The control system could similarly regulate that the electrical load 604 was not underpowered by disconnecting the system when the maximum power usage was reached.

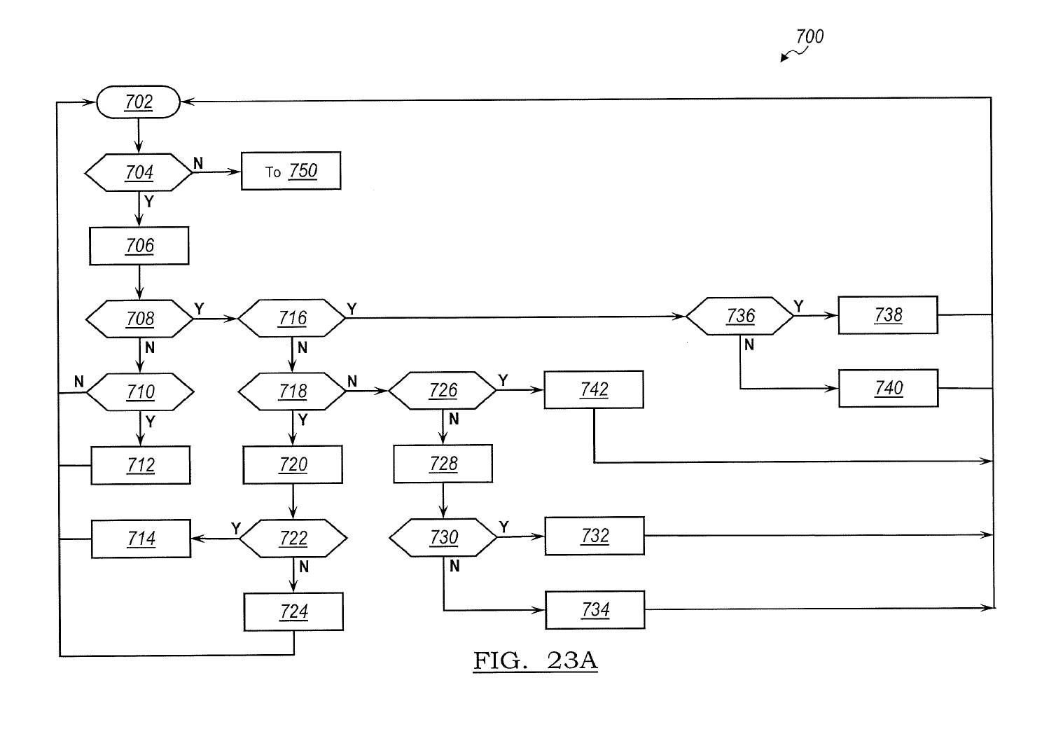

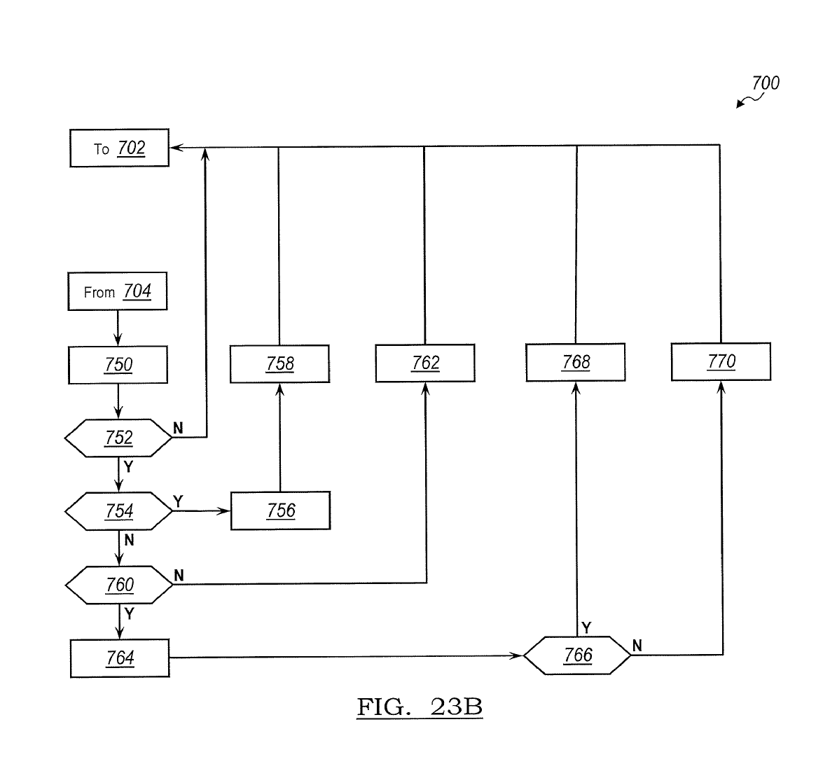

FIG. 23 depicts a method 700 representing a control algorithm of the power management system according to one embodiment of this disclosure. Once initialized at step 702, an algorithm of the control system may first determine whether there is sunlight at step 704. Sunlight detection may be performed using separate light detection mechanisms or a portion of the solar collector panel array. In at least one embodiment a light sensor is disposed on the solar collector panel array and may trigger a “wake up” of the solar collector panel array, and initiate a daytime collection portion of the algorithm. After the detection of sunlight, the control system may deploy the solar collector panel array at step 706.

At step 708, the control system determines whether an electrical load is present. The user may also indicate whether a load is present via a user input interface. As described above, a small power source such as a capacitor may also be used to determine the presence of an electrical load. The capacitor may be connected to the load in isolation, and become depleted in response to an active load. Another method to determine the presence of a load is by using visual sensors to detect the physical presence of a device plugged in to an outlet portion of the solar collector panel array.

When no load is present, the controller receives input at step 710 of whether the battery SOC is less than maximum charge. If the battery SOC is less than maximum charge, the controller may then issue a command for the electrical system to recharge the battery using energy from the solar collector panel array at step 712.

When an electrical load is present at step 708, the controller determines whether the solar collector panel array can alone provide enough electricity to satisfy the load at step 716. Solar collection may not alone provide enough electricity due to the maximum rating of the solar collector panel array, or due to a diminished amount of solar energy provided relating to clouds, time of day, windy conditions, or other factors.

If the solar collector panel array does not provide enough energy for the load, as determined at step 716, the controller may use the battery to provide some of the energy required by the load. However, before using the battery, the controller determines the SOC of the battery at step 718. If the battery SOC is less than or equal to a low SOC threshold, the controller will prioritize using the generator for power over depleting the battery. The controller issues a command at step 720 to start the generator to provide the remaining power required. The controller may then use the generator in parallel with the solar collector to satisfy the electrical load.

At step 722, if the battery SOC is less than or equal to a critical SOC threshold, the controller may additionally connect the battery at step 714 while the generator is running to use a portion of the power provided by the solar collectors and generator to recharge the battery. If the battery SOC is greater than the critical SOC threshold at step 722, the controller may issue a command at step 724 for the solar collection and generator output to supply the electrical load.

If the battery SOC is greater than the low SOC threshold at step 718, the controller may allow the battery to provide power to supply the load. If the solar collector panel array and the battery combined produce enough power to supply the load at step 726, then the controller issues, at step 742, for the solar collector panels and the battery to supply power for the load without running the generator. If consumption of power is less than the solar collector panel array then the generator is cut off.

If at step 726 the battery and the solar collector panel array combined are unable to produce sufficient power to satisfy the load then the controller issues a command at step 728 to start the generator. If at step 730 the total power available is greater than the electrical load, all three power sources (generator, battery, and solar collector panel array) provide energy to satisfy the load at step 732. If at step 730 the load is above the maximum available energy from all three power sources, then the solar collection system will trip and/or provide the user with indication that the load is underpowered at step 734.

When the solar collection from the collector panel array is greater than the electrical load at step 716, the control system may use the excess solar energy to recharge the battery. If the battery SOC is less than the maximum SOC threshold at step 736, the controller may issue a command at step 738 to utilize the excess solar energy to recharge the battery at the same time as supplying the load. If the battery SOC is at the maximum SOC threshold at step 736, the system may be configured to not recharge the battery and only supply the electrical load using solar energy at step 740.

Referring to FIG. 24, the controller has determined that sunlight is not available from step 704. When no sunlight is available, the controller for the solar collector panel array may issue a command to articulate the panel array into the sleep configuration at step 750. The system still may be capable of providing power to supply an electrical load while in the sleep configuration. The controller is programmed to first determine whether an electrical load is present at step 752. If a load is present the system may determine the battery SOC at step 754. If the state of charge less than or equal to the critical SOC threshold, the controller may issue a command to start the generator at step 756. In the case of a critical SOC, the controller may issue a command to allocate a portion of the power output from the generator to recharge the battery. In. this way damage to the battery cells stemming from over-depletion may be avoided. At step 758 power from the generator may be allocated to supply the load and recharge the batteries.

If the battery SOC is greater than the critical SOC threshold at 754, the controller may determine whether the SOC is greater than the low SOC threshold. If the battery SOC is greater than the low threshold at 760, the controller may issue a command at 762 causing the battery to supply all the energy to satisfy the load.

If the battery SOC is less than the low SOC threshold at 760 then the controller will issue a command to start the generator at 764. The controller then assesses at step 766 whether the load is less than the generator power output when run at a fuel efficient speed and load. If the load is less than the generator fuel efficient power output (FEPO), there may be excess power available to recharge the battery. If the load is less than the FEPO of the generator at step 766, the controller may issue a command at step 768 to allocate generator output power both to supply the load and recharge the battery.

If at step 766 the power demand from the electrical load is greater than the maximum generator power output, the controller may issue a command at step 770 to cause the load to be supplied by both generator output and power drawn from the battery.

It should be appreciated that method 700 is a looping algorithm that continually monitors the power inputs and outputs of solar collector system. Each of the decision paths loops back to the initialization step 702 to assess system parameters on an ongoing basis. Since system parameters such as battery SOC, sunlight availability, and consumer electrical load can vary, the controller makes automatic optimization decisions to most efficiently manage power distribution.

The system monitors the SOC of the batteries and may provide users with a warning if the SOC falls below a predetermined threshold of 35-70% and preferably 50-65%. In the illustrated embodiment, this notification threshold is set at about 58-60%. The notification alerts the user that sufficient power may not be available for an entire night or that the generator is required.

While embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electricity production system comprising:
a solar energy collector for receiving sunlight and providing electricity to an electrical load;
a battery for storing energy and providing electricity to the electrical load;
a generator for providing electricity to the electrical load; and
a controller programmed to issue commands to distribute electrical output such that electricity required for the load is available from at least one of the solar energy collector, the battery, and the generator,
wherein the commands to distribute electrical output reduce usage of the battery and generator based on at least one of an anticipated sun load and expected customer usage.

2. The electricity production system of claim 1, wherein the controller is further programmed to issue a command in response to (i) received sunlight and (ii) electrical load less than a threshold, such that the solar energy collector provides electricity required to satisfy the electrical load.

3. The electricity production system of claim 1, wherein the controller is further programmed to issue a command in response to (i) no received sunlight and (ii) a battery state of charge greater than a charge threshold, such that the battery provides electricity required to satisfy the electrical load.

4. The electricity production system of claim 1, wherein the controller is further programmed to issue a command in response to (i) no received sunlight and (ii) a battery state of charge less than a charge threshold, such that the generator provides electricity required to satisfy the electrical load.

5. The electricity production system of claim 1, wherein the controller is further programmed to issue a command in response to (i) received sunlight, (ii) electrical load greater than solar collector electricity output, and (iii) a battery state of charge greater than a charge threshold, such that the solar energy collector and the battery cooperate to provide electricity required to satisfy the electrical load.

6. The electricity production system of claim 1, wherein the controller is further programmed to issue a command in response to (i) received sunlight, (ii) electrical load greater than a solar collector electricity output, and (iii) a battery state of charge less than a charge threshold, such that the solar energy collector and the generator cooperate to provide electricity required to satisfy the electrical load.

7. The electricity production system of claim 1, wherein the controller is further programmed to issue a command in response to (i) no received sunlight and (ii) electrical load greater than a generator output, such that the generator and the battery cooperate to provide electricity required to satisfy the electrical load.

8. The electricity production system of claim 1, wherein the controller is further programmed to issue a command in response to an electrical load greater than an extreme load threshold such that the generator, the solar energy collector, and the battery cooperate to provide electricity required to satisfy the electrical load.

9. The electricity production system of claim 1, wherein the controller is further programmed to vary a battery low state of charge threshold based on at least one of anticipated sun load and expected customer usage.

10. The electricity production system of claim 1, wherein the controller is further programmed to vary a maximum battery state of charge threshold based on at least one of the anticipated sun load and expected customer usage.

11. The electricity production system of claim 1, wherein the controller is further programmed to vary a critical battery state of charge threshold based on at least one of the anticipated sun load and expected customer usage.

12. The electricity production system of claim 1, wherein the system has a solar panel collector array power rating of at least 1 KW and as a unit can fit within a container having an internal volume of at least 1800 ft³.

13. The electricity production system of claim 12, wherein the container is an intermodal hi-cube shipping container.

14. A mobile electricity production system comprising:
a trailer including a frame, a plurality of wheels, and a hitch;
a solar collector panel array pivotally attached to the frame and articulable to receive sunlight and output electricity;
a generator attached to the frame and configured to output electricity;
a battery attached to the frame and configure to store electricity and to output electricity; and
a controller programmed to issue commands to distribute electrical output such that electricity required for an electrical load is satisfied from at least one of the solar collector panel array, the battery, and the generator.

15. The mobile electricity production system of claim 14 wherein the at least one solar collector panel array is configured to pivot about a horizontal axis and a vertical axis.

16. The mobile electricity production system of claim 15 further comprising a pitch adjustment mechanism configured to regulate a pitch angle about the horizontal axis of the at least one solar collector panel array relative to the frame.

17. The mobile electricity production system of claim 15 further comprising a rotation adjustment mechanism configured to regulate a rotation angle about the vertical axis of the at least one solar collector panel array relative to the frame.

18. The mobile electricity production system of claim 15 wherein the solar collector panel array defines a travel configuration where a plurality of solar panels are stowed in a stacked arrangement proximate to the frame.

19. The mobile electricity production system of claim 15 wherein the solar collector panel array defines a deployed configuration where a plurality of solar panels are unfurled to an upright arrangement to receive sunlight.

20. The mobile electricity production system of claim 15 wherein the solar collector panel array includes a plurality of individual solar panels hingedly connected to one another and articulable between a travel configuration and a deployed configuration.
